(19) United States
(12) Patent Application Publication
(10) Pub. No.: US 2009/0049555 A1
(43) Pub. Date: Feb. 19, 2009

(54) METHOD AND SYSTEM OF DETECTING ACCOUNT SHARING BASED ON BEHAVIOR PATTERNS

(75) Inventors: Sungzoon Cho, Seoul (KR); Seong Seob Hwang, Seoul (KR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: SEOUL NATIONAL UNIVERSITY INDUSTRY FOUNDATION, Seoul (KR)

(21) Appl. No.: 12/133,931

(22) Filed: Jun. 5, 2008

(30) Foreign Application Priority Data
Aug. 16, 2007 (KR) 10-2007-0082254

(51) Int. Cl. G06F 21/00

(52) U.S. Cl. 726/26

(57) ABSTRACT

A system of detecting account sharing, based on analysis of users' behavior patterns is provided. In the present invention, the system comprises: a user authentication information database storing keystroke dynamics patterns related to a particular account in association with the account; and a sharing detection analyzer to analyze a cluster distribution of the keystroke dynamics patterns stored in the user authentication information database to determine whether the account is shared.

The present application claims priority to Korean Patent Application No. 10-2007-0082254 entitled “METHOD AND SYSTEM FOR DETECTING ACCOUNT SHARING BASED ON BEHAVIOR PATTERNS,” and filed on Aug. 16, 2007, the subject matter of which is incorporated herein by reference.

### BACKGROUND OF THE INVENTION

1. Field of the Invention

The present invention generally relates to supervision of users' accounts in the provision of Internet services, and more particularly, to a method and system of detecting account sharing among Internet users based on an analysis of the users' behavior patterns.

2. Description of the Related Art

Most Internet service providers require users, who attempt to connect to those services through the wired or wireless Internet, to first create their personal accounts and logon to the services by using the same accounts. By doing so, the service providers can identify the users connecting to the services and provide the services in a more controlled manner. In such an environment, however, the service provider may frequently be confronted with the problem of “account sharing” where a plurality of users share a single account for a particular service against the service provider's intent.

The users may try to share the single account for a particular service for a few reasons. One of them is related to the reduction of service fees. Recently, various kinds of on-line services, such as multimedia services and e-learning services, are provided, for which fees are charged to the users. In such a service environment, the situation may arise where a certain user creates an account for the service, and other users having some relationship with the above user share information regarding the account (e.g., user ID and password). In such situation, all the users can use the service by paying a fee for only one user. Another reason is that the users may feel the process for creating a new account for a service complicated or uncomfortable. When the user creates a new account, most Internet service providers require the user to submit a lot of information about the user for the purpose of preventing duplication in membership or acquiring marketing information. Therefore, the users may feel the process for creating the new account complicated or uncomfortable.

The account sharing may cause several problems to Internet service providers. First, service providers' profits decrease due to the sharing of a paid or premium account. Second, the number of users, which is counted based on the number of accounts, becomes lower than the actual number of users actually using the service. This leads to undervaluation of the Internet service, considering that the number of customers using the Internet service is the most important basis for evaluating the service. Third, in terms of customer management, the account sharing makes it difficult to provide each user with a personalized service. Finally, too much load may be imposed upon the network managed by the service provider due to the illegal account sharing.

Therefore, most Internet service providers provide a rule for preventing account sharing so that users cannot share an account. For example, when a user creates a new account in an Internet portal or game portal, the service provider provides to the user a notice regarding the rule (e.g., the rule under which if account information, such as a user ID and password, is exposed to other person and the other person uses the account, then the service becomes limited or the contract between the provider and the user gets cancelled).

Since some users intend to share their accounts despite of such rule, a technique for detecting such account sharing is required. For example, Juniper Networks, Inc. provides the Steel-Belted Radius Service Level Manager, a network device for detecting account sharing. The device enables the provision of services in a manner to prevent a user from using beyond the limitation of the service, to detect account sharing, to check embezzlement of an account, and to sell various types of family accounts (under the family accounts contract, the number of users who can use the account is unlimited but the number of users who can access the service at the same time is limited). Particularly, this device identifies a user's information, such as an IP address. If the user's IP address is not predetermined or the user is connected from any other IP addresses except from the predetermined address, the device presumes that the user's account is being shared. However, despite of using such device, it is impossible to detect a plurality of users sharing an account by connecting to a server from the same IP address.

To resolve the above mentioned problem, several systems and methods for monitoring IP address sharing by an IP sharer were suggested. In these methods, after one account is assigned from an Internet service provider, a plurality of users using the service through an IP sharer is detected.

An example of such systems and methods is disclosed in Korean Patent No. 588352. In the example, a packet detector of an IP sharer monitoring system detects IP packets, which are communicated via the Internet, and transfers the detected packets to an ID analyzer. The ID analyzer extracts ID values from the ID headers in the packets sent from the packet detector, and based on the number of the ID values, the ID analyzer decides whether an IP sharer is being used. When the system determines that an IP sharer is being used, a notifier sends a notice packet to a user's PC, which is presumed to use the IP sharer, and a private IP detector detects the private IP address of the user's PC from the notice packet sent from the notifier. After a user interrupter identifies whether the user indeed uses the IP sharer, based on the detected private IP address, it interrupts the Internet connection of the user of the IP sharer. Alternatively, the notifier may generate a notice packet for leading the user to register a normal Internet line, and transfer the packet to the user, without interrupting the Internet connection of the user.

However, such system for detecting account sharing by an IP sharer also has a problem that while a plurality of PCs using one account at the same time by an IP sharer can be detected, a plurality of users using one account at different times through one PC cannot be detected. For detecting such type of account sharing, use patterns or unique characteristics of the users commonly using one account can be considered. As the users' unique characteristics, biological information may be used. However, using the biological information requires a device for recognizing the biological information, and such device may make the users feel it difficult to use the service. Further, if the users are aware that detecting account sharing is being applied, they may feel uncomfortable.

### SUMMARY OF THE INVENTION

A method and system of detecting account sharing based on a behavior pattern, such as user's keystroke dynamics, are disclosed. For example, keystroke dynamics may be a timing vector indicating a typing pattern of any strings inputted by a user. The timing vector is a vectorized value from a duration of pushing a key (input duration) and an interval value between the pushes of keys, that is, information regarding the duration of a user's typing strings.

Generally, it is known that the duration of typing strings varies depending on users typing the strings. Thus, keystroke dynamics may be a kind of biometrics, which is recently used for authentication of a user (see Cho, S., Han, C., Han, D., & Kim, H. (2000). Web Based Keystroke Dynamics Identity Verification Using Neural Networks. Journal of Organizational Computing and Electronic Commerce, 10(4), 295-307, and Yu, E. & Cho, S. (2004) Keystroke Dynamics Identity Verification—Its Problems and Practical Solutions. Computers and Security, 23(5), 428-440). For example, when logging on to a web site, a user inputs his/her ID and password, and then, the authentication module of the web site identifies whether the inputted password is identical to the password which is stored for the user's registration. If so, the authentication module allows the login. Therefore, anyone who knows the user's ID and password can log on to the website with that information. On the contrary, according to the keystroke dynamics authentication method, for an authentication of a user, the authentication of a web site uses both the user's password and the keystroke dynamics of the user's typing the password. Thus, an illegal use of the user's account can be prevented since it's almost impossible to acquire account information of a user, the keystroke dynamics of the user's inputting the password, even when the password is acquired. Such user authentication method using keystroke dynamics leads to the effect that the security of a password-based authentication system is enhanced. Further, since this method can be implemented based on software only without hardware for inputting user's biological information, the cost for performing the method becomes very low, users do not feel aversion to the user authentication process, and a security token (a handheld device used for user authentication, which is designed to store a user's electrical sign or biometrics information) is not required.

The present invention is based on detecting account sharing by an analysis of user's keystroke dynamics. According to one embodiment, a method and system of detecting account sharing demand that a user of a target service which needs detection of account sharing inputs predetermined strings. For example, the predetermined strings may be a password, or any strings may be suggested to the user to be inputted by the user after login. Then, the method and system collect the keystroke dynamics pattern data of users' inputting the strings for a predetermined time (e.g., several months) and store the pattern data in a database. After the predetermined time, the method and system determine whether an account is shared, depending on a clustering analysis of the keystroke dynamics pattern data stored in the database. For example, if all inputted keystroke dynamics pattern data are similar to each other to form one cluster, the method and system determine that the account is not shared. On the contrary, if the data form two or more clusters, it is determined that the account is shared.

### BRIEF DESCRIPTION OF THE DRAWINGS

The foregoing and other aspects and advantages are better understood from the following detailed description of a preferred embodiment of the invention with reference to the drawings, in which:

FIG. 1 illustrates a system of detecting account sharing according to an embodiment of the present invention.

FIG. 2 illustrates that the system of detecting account sharing in FIG. 1 is combined with an Internet service provider's system according to an embodiment of the present invention.

FIG. 3 is a block diagram of a pattern collector according to an embodiment of the present invention.

FIGS. 4A to 4D illustrate keystroke dynamics patterns by a behavior pattern extraction unit according to an embodiment of the present invention.

FIGS. 5A and 5B illustrate authentication information database according to embodiments of the present invention.

FIGS. 6A to 6F show results of experiments of mathematical statistical analyses for determining whether an account is shared according to embodiments of the present invention.

FIG. 7 is a flow chart of a method of detecting account sharing according to an embodiment of the present invention.

### DETAILED DESCRIPTION OF THE PREFERRED EMBODIMENT

Hereinafter, an embodiment of the present invention will be described in detail with reference to the accompanying drawings. However, it should be understood that the present invention is not limited to the embodiment.

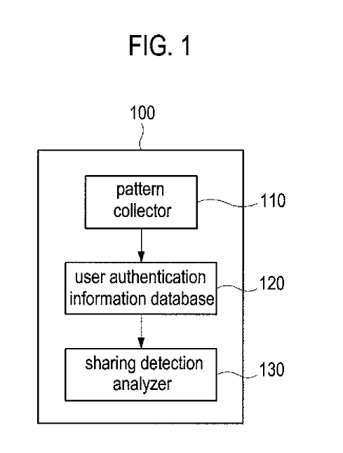

FIG. 1 shows an account sharing analysis system according to an embodiment of the present invention. As shown in FIG. 1, the account sharing analysis system 100 comprises a pattern collector 110 to collect keystroke dynamics patterns from a user, a user authentication information database 120 to store the data collected by the pattern collector 110, and a sharing detection analyzer 130 to detect account sharing based on analysis of the data stored in the user authentication information database 120. The account sharing analysis system 100 may be implemented by being combined with a service provider's system to provide a service via an Internet network.

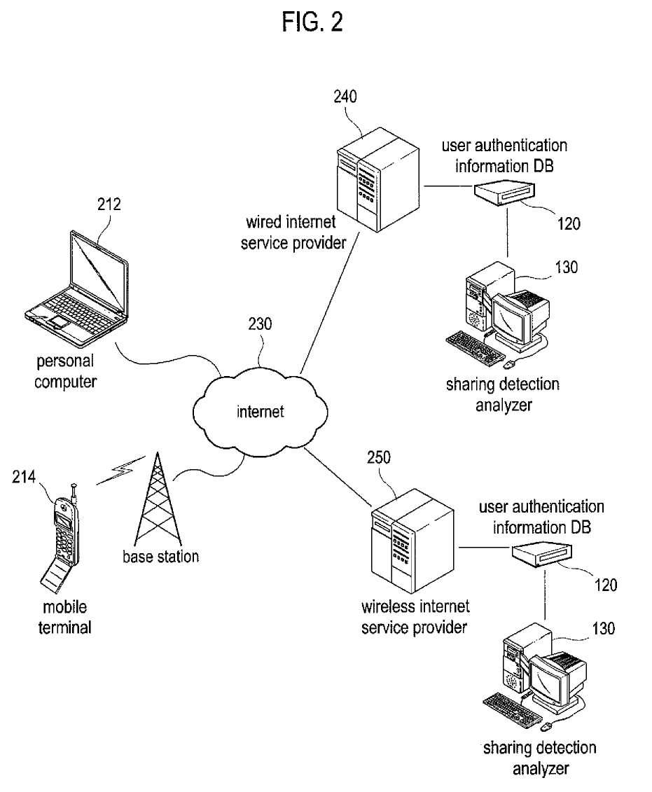

FIG. 2 shows an embodiment where the account sharing analysis system 100 is combined with the service providers system on the Internet network. As shown in FIG. 2, the pattern collector 110 of the account sharing analysis system 100 may be implemented in users' terminals 212 and 214. The pattern collector 110 may be may be a plug-in installed in the terminals 212 and 214. For example, if a user's personal computer 212 is provided with a specified service from a service provider's server 240 via an Internet network, the pattern collector 110 installed in the personal computer 212 may extract and collect a keystroke dynamics pattern from the user's inputting account information on the login window of the web page for providing the service. Similarly, if a mobile terminal 214 is provided with the service from a service provider's server 250, the pattern collector 110 installed in the mobile terminal 214 may collect the keystroke dynamics pattern of the user. Such keystroke dynamics pattern information is transferred to a user authentication information database 120 connected to the service provider's servers 240 and 250, and stored in the database. Although FIG. 2 shows the case where the user is provided with the service through the personal computer 212 or the mobile terminal 214, the user's terminal is not limited to them, and it is obvious to one of ordinary skill in the art that the present invention may be applied to any terminal which can be connected to a network, such as a notebook, a PDA, an Internet-connectable TV, a WiFi phone, a Wibro phone, any mobile devices, etc.

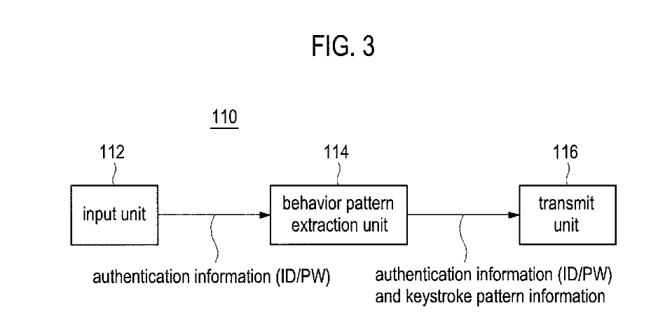

FIG. 3 is a block diagram of a pattern collector 110 according to an embodiment of the present invention. As shown in FIG. 3, the pattern collector 110 comprises an input unit 112 for a user's inputting account information, such as the user's ID and password, an extraction unit 114 to extract the user's behavior pattern, such as the keystroke dynamics of the inputted account information, and a transmit unit 116 to send the extracted behavior pattern to the user authentication information database 120.

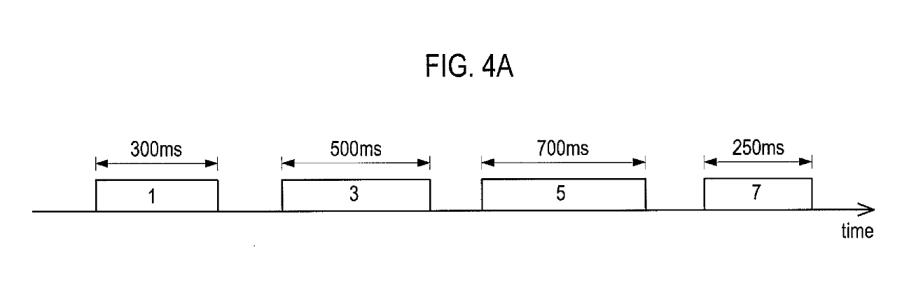

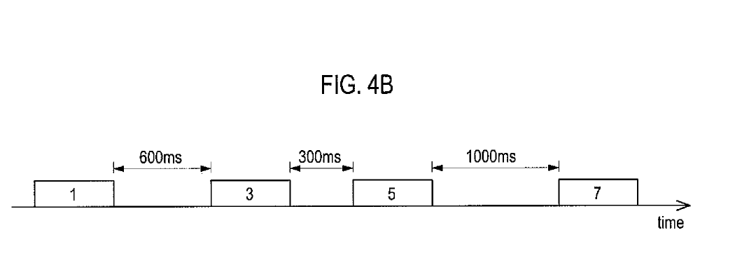

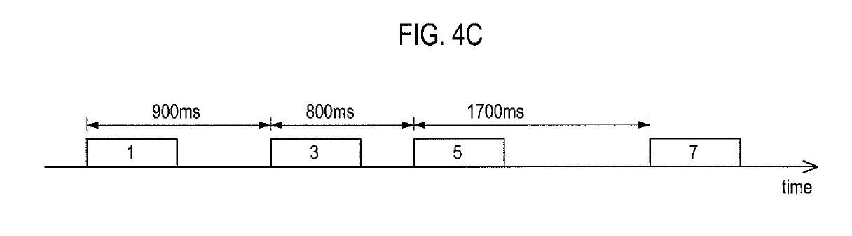

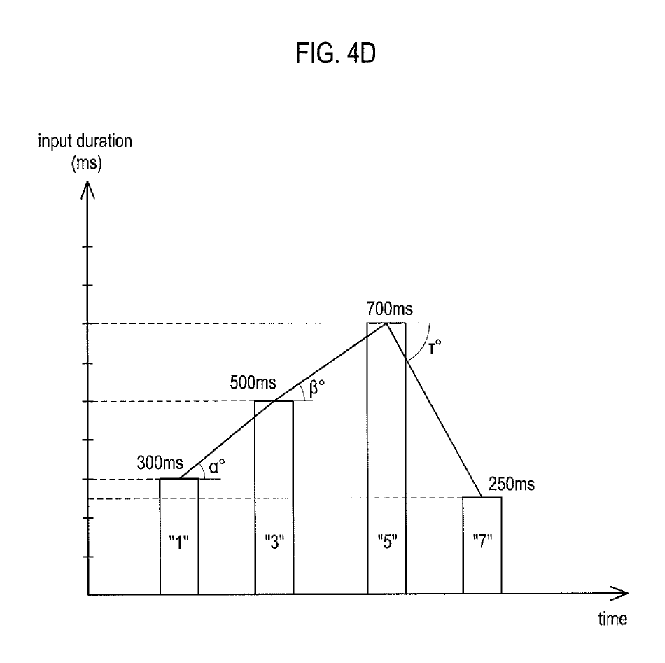

For example, if the user inputs a service account information (including the user's ID and password) through a device, such as a keypad in the user's terminal, the input unit 112 of the pattern collector 10 transfers the inputted keystroke data to the behavior pattern extraction unit 114. The behavior pattern extraction unit 114 may extract one or more keystroke dynamics patterns from the keystroke data, which may include an input duration, an interval, a latency time, and a pattern based on a bar graph. Hereinafter, keystroke dynamics patterns extracted by the behavior pattern extraction unit 114 will be described in detail with reference to FIGS. 4A to 4D.

The input duration indicates the duration of times the user pushes a key. For example, assume that the user's password which has four numbers (e.g., “1,” “3,” “5,” and “7”) is inputted through the input unit 112. As shown in FIG. 4A, if “1” is pushed for 300 ms, “3” is pushed for 500 ms, “5” is pushed for 700 ms, and “7” is pushed for 250 ms, the durations of inputting the password, “1, 3, 5, 7,” are “300 ms, 500 ms, 700 ms, and 250 ms,” and all or some of the durations may be used as keystroke dynamics pattern information.

An interval is a time gap between the user's inputs of keys. For example, as shown in FIG. 4B, if the time gap between the end of the user's push of “1” and the start of the user's push of “3” is 600 ms, and if the time gap between the end of the user's push of “3” and the start of the user's push of “5” is 300 ms, and if the time gap between the end of the user's push of “5” and the start of the user's push of “7” is 1000 ms, then the intervals of the password, “1, 3, 5, 7,” are “600 ms, 300 ms, and 1000 ms,” and all or some the intervals may be used as keystroke dynamics pattern information. Further, for example, the interval between the pushes of three or more keys (e.g. between “1” and “5”) may also be used as keystroke dynamics pattern information. Furthermore, if the user pushes a confirmation (or RETURN) key after inputting the password, the time gap between the push of “7,” which is the last key of the password, and the push of the confirmation key may also be included in the intervals.

Meanwhile, a latency time indicates the time gap between start of pushing a key and start of pushing the next key. For example, as shown in FIG. 4C, the time gap between start of pushing “1” and start of pushing “3” is 900 ms, the time gap between start of pushing “3” and start of pushing “5” is 800 ms, and the time gap between start of pushing “5” and start of pushing “7” is 1700 ms, the latency times for the password, “1, 3, 5, 7,” are “900 ms, 800 ms, and 1700 ms,” and all or some of the latency times may be used as keystroke dynamics pattern information.

As shown in FIG. 4D, the measured durations are represented as bar graphs, and the angles between the horizon and each of the lines connecting the top points of the bar graphs (α°, β°, γ°) may be used as keystroke dynamics pattern information.

The keystroke dynamics patterns, such as the duration, interval, and latency time as described above, may be transferred to the database through the transmit unit 116, or may be converted to other kinds of values to be transferred to the database. Further, any combination of the keystroke dynamics patterns as shown in FIGS. 4A to 4D may be used as pattern information. That is, all types of information, which can be acquired from any typing patterns extracted from the user's input, may be used as keystroke dynamics pattern information.

Moreover, although the keystroke dynamics pattern information as explained above is related to the case which the user inputs a password with a plurality of strings through a keypad with a plurality of keys, it is not limited to the case. That is, if a terminal has only one key, button push dynamics pattern information may be extracted. For example, the keystroke dynamics pattern information may be extracted from all input patterns, which can occur when a user pushes the key one or more times, (e.g., duration and interval, etc.).

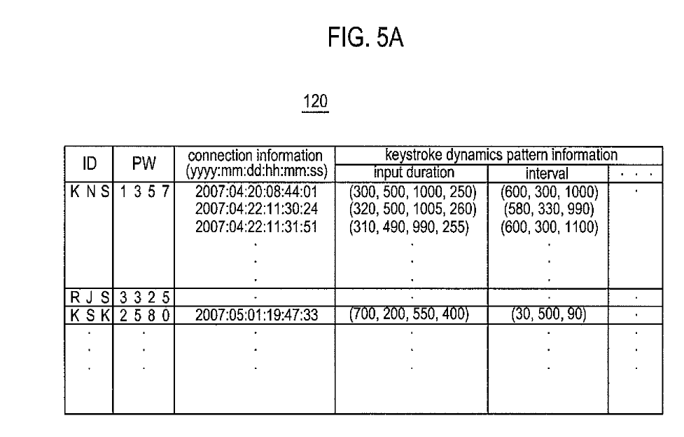

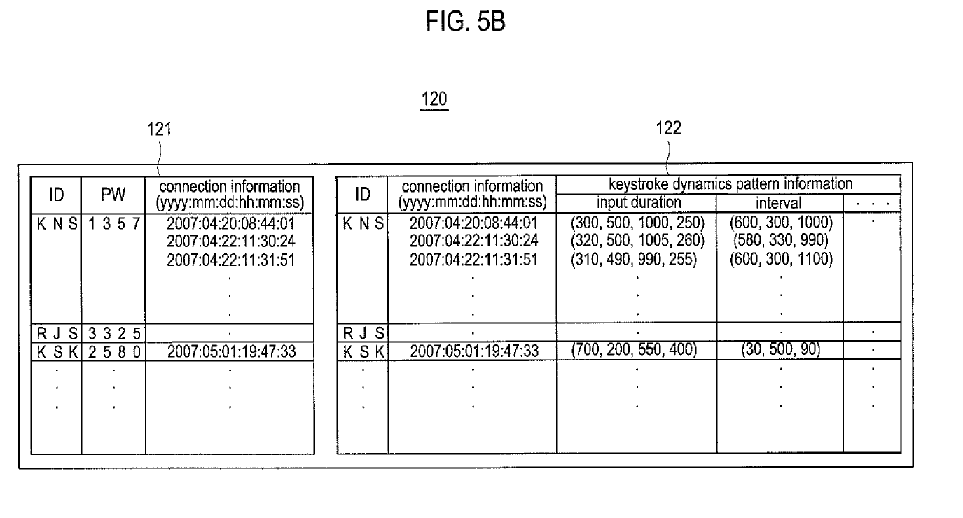

FIGS. 5A and 5B illustrate an example of user authentication information and keystroke dynamics pattern information stored in a user authentication information database 120 according to an embodiment of the present invention. As shown in FIG. 5A, the user authentication information database 120 may store the keystroke dynamics pattern information in association with conventional authentication information, such as a user's account, password, and connection information. Further, as shown in FIG. 5B, the database 120 may include a first database 121 storing the conventional authentication information, such as the user's account, password, and connection information, and a second database 122 storing the keystroke dynamics pattern information in association with the user's account.

Referring to FIG. 1 again, the sharing detection analyzer 130 analyzes the keystroke dynamics pattern information stored in the user authentication information database 120 to determine whether the account is shared, and then, to estimate the number of users who share the account. According to an embodiment of the present invention, the sharing detection analyzer 130 may use measurement of how much the keystroke dynamics pattern information is dispersed, and/or how many clusters of the keystroke dynamics pattern there are. For example, the measurement of degree of dispersion may include Adjusted Within-Cluster Scatter (ASW), and the estimation of an optimum number of clusters may use Gaussian Mixture Model (GMM). Hereinafter, the methods based on the ASW and the GMM will be described in detail. However, these are embodiments applicable in the present invention which is not limited to the embodiments, and it is obvious to one of ordinary skill in the art that any mathematical or statistic methods, which are used in the measurement of degree of dispersion or the presumption of an optimum number of clusters, may be applied to the present invention.

First, an analysis based on the ASW will be explained. If N keystroke dynamics pattern information (x¹, x², . . . , x^{N}) are collected with regard to an account, the ASW value indicating the degree of scatter of the N data may be determined by:

$$ASW = \frac{1}{N} {\sum }_{i} distance ( {x}^{i} , m ) , i = 1 , ... , N \qquad ( Equation 1 )$$

Wherein the distance (xⁱ, m) is a function of the distance between xⁱ and m, and m is the centroid or the mean of the N data (x¹, x², . . . , x^{N}) as follows:

$$m = \frac{1}{N} {\sum }_{i} {x}^{i} , i = 1 , ... , N \qquad ( Equation 2 )$$

That is, according to Equation 1, since the ASW value is the mean of the N data (x¹, x², . . . , x^{N}) and the mean value m, it numerically represents the degree of scatter of the N data.

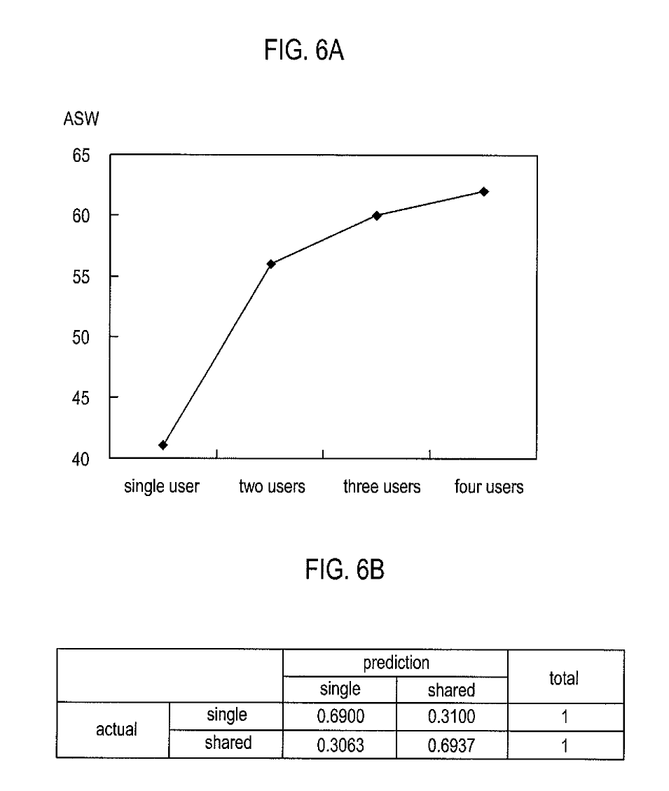

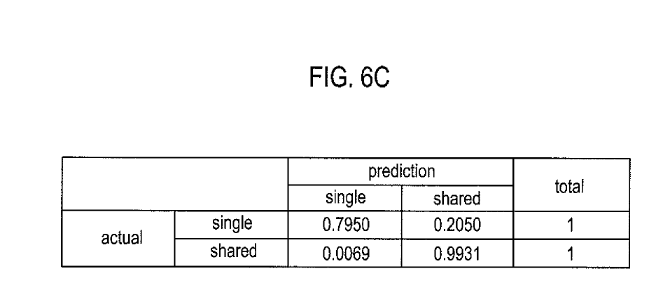

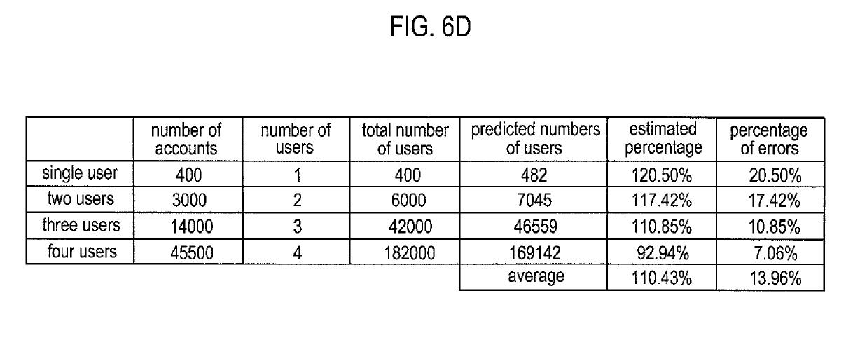

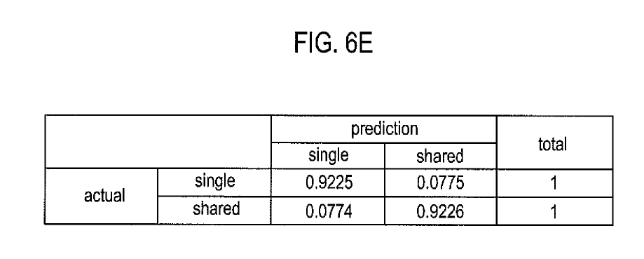

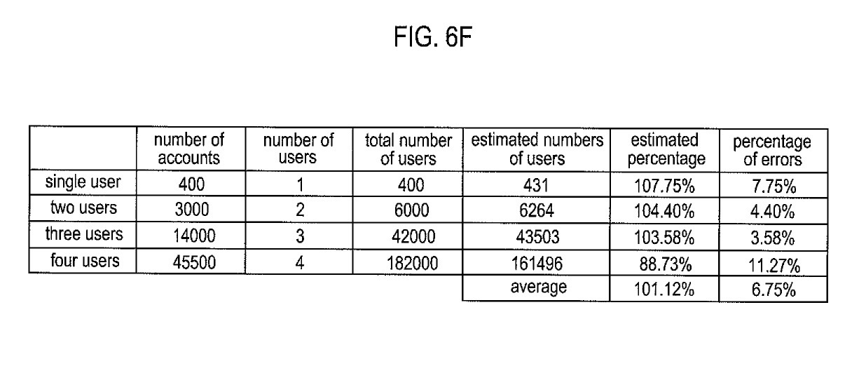

FIG. 6A is an experimental graph of ASW values depending on the numbers of users sharing one account. As shown in FIG. 6A, as the number of users sharing an account increases, the ASW value also increases. As described above, since the ASW value numerically represents the degree of scatter of the keystroke dynamics pattern information, the degree of scatter of the data increases as the number of the users sharing the account increases. Considering this tendency, a specified account is determined as shared if ASW for use account u is larger than θ:

ASWᵤ>θ (Equation 3)

Wherein θ is a predetermined threshold and u is a user's account. That is, after the threshold θ is determined based on the tendency as shown in FIG. 6A, if the ASW value ASWᵤ associated with the user's account u is greater than the threshold θ, then it can be determined that the account u is shared, and if the ASW value ASWᵤ associated with the user's account u is equal to or less than the threshold θ, it can be determined that the account u is not shared. In this regard, if the threshold θ is set too high, the number of misses (an account shared by a plurality of users is not detected) increases, and if the threshold θ is set too low, the number of false alarms (an account used by only one user is determined as if shared by a plurality of users) increases. Thus, the threshold θ may be set as the value which can minimize both the misses and false alarms. According to an embodiment of the present invention, the threshold θ may range from 30 to 60, and in the experiment by the inventor of the present invention, the misses and false alarms were minimized when the threshold θ was 47. However, the threshold θ is not limited to this; the optimum value of the threshold θ may vary depending on the number of collected data, or a type of a user's terminal, or a type of a system. Hereinafter, the experimental results of detecting account sharing based on the above ASW method will be explained.

In this experiment, the data set consists of sixteen users, and 30 patterns in association with each of 25 passwords were collected from all of the users. The users have different abilities to type, and the familiarities to each account may also be different. For this difference, the inventor performed the experiment with various combinations. One user is chosen as a legitimate user for a password. Then other user's patterns for that password are added to form a shared account dataset. Since, in this experiment, the data were collected from 16 users for 25 passwords, the number of different datasets that the accounts are used by one user is 25×₁₆C₁=400, and the number of different datasets that the accounts are shared by two users is 25×₁₆C₂=3000. Similarly, the number of different datasets that the account are shared by three users is 25×₁₆C₃=14000, and the number of different datasets that the accounts are shared by four users is 25×₁₆C₄=45500. For practical purposes, the different datasets that the accounts are shared by five or more users were excluded. The data set from the collected data is organized in the table below. For example, since the number of accounts shared by two users is 3000 and each account is used by two users, the total number of users is 6000.

TABLE 1

| | Number of | Number of | Total Number |
|---|---|---|---|
| | Accounts | Users | of Users |
| One user | 400 | 1 | 400 |
| Two users | 3000 | 2 | 6000 |
| Three users | 14000 | 3 | 41000 |
| Four users | 45500 | 4 | 171000 |

In this experiment, the cases of using only patterns of available users were defined as a single usage, and the cases of using patterns of two to four users were defined as account sharing. That is, based on one threshold, the single usage or the account sharing is determined. FIG. 6B shows the results based on such definition. Referring to FIG. 6B, the percentage of correctly detecting the single usage is 69%, the percentage of correctly detecting the account sharing is 69.37%, the percentage of the false alarm that the single usage is regarded as the account sharing is 31%, and the percentage of the miss that the account sharing is regarded as the single usage is 30.63%.

Next, the analysis method based on the GMM will be explained. If N keystroke dynamics pattern information (x¹, x², . . . , x^{N}) is collected with regard to an account, and the data are distributed to form several clusters, the number of the clusters (K*), which best describes the data, can be selected with consideration of goodness-to-fit and model complexity. This optimum number of the clusters (K*) can be used as an estimate for the number of the users sharing the account.

More particularly, N keystroke dynamics pattern information (x¹, x², . . . , x^{N}) is collected, and if the data form K clusters (K≦N) and the GMM for the K clusters is M_{K}, then the probability distribution of the data (x¹, x², . . . , x^{N}) is presumed as:

$$\hat{p} ( x \vert {M}_{κ} ) = {\sum }_{k = 1}^{κ} [ \hat{P} ( k ) \hat{p} ( x \vert k ) ] \qquad ( Equation 4 )$$

Wherein \hat{P}(k) is the prior probability of the k^{th} cluster, and the conditional probability, p(x|k), is as follows:

$$p ( x \vert k ) = \frac{1}{{( 2 π )}^{d / 2} {\vert {Σ}_{k} \vert}^{1 / 2}} exp \{ - \frac{1}{2} {( x - {μ}_{k} )}^{T} {Σ}_{k}^{- 1} ( x - {μ}_{k} ) \} \qquad ( Equation 5 )$$

Wherein μₖ is the mean vector of the k^{th} cluster, and Σₖ is the covariance matrix of the k^{th} cluster.

Then, the goodness-of-fit of the GMM M_{K} is generally calculated as the log-likelihood of the GMM M_{K} as follows:

$$L ( {M}_{k} ) = \frac{1}{N} {\sum }_{n = 1}^{N} log \hat{p} ( {x}^{n} \vert {M}_{k} ) \qquad ( Equation 6 )$$

However, since such logarithm (L(Mₖ)) tends to increase as k increases, regardless of the distribution of the data, it may be determined that the optimum number of the clusters (K*) is N. Therefore, various criteria or penalty terms for the complexity of the GMM M_{K} are added to the logarithm. The following equations are examples of penalty terms.

(i) AIC (Akaike information criterion) (Akaike, 1974)

AIC(Mₖ)=−2L(Mₖ)+2Nₚ(Mₖ) (Equation 7)

(ii) BIC (Bayesian information criterion) (Schwarz, 1978)

BIC(Mₖ)=−2L(Mₖ)+Nₚ(Mₖ)ln N (Equation 8)

(iii) ED (Evidence Density) (Roberts, 1997)

$$ED ( {M}_{k} ) = L ( {M}_{k} ) / {\sum }_{k = 1}^{κ} \sqrt{\vert {Σ}_{k} \vert} \qquad ( Equation 9 )$$

The number of the clusters (K*), which best describes the dataset, can be estimated based on at least one of the above values, AIC, BIC, and ED. As for the AIC (Mₖ) value calculated from Equation 7 and the BIC (Mₖ) value calculated from Equation 8, the k value which minimizes the values is the optimum number of the clusters. As for the ED (Mₖ) value, the k value to maximize the ED (Mₖ) value is the optimum number of the clusters. FIG. 6C shows the accuracy of detecting the single usage or the sharing by 2 to 4 users by using the above GMM method, and in FIG. 6C, the percentages of correctly detecting the single usage and the account sharing were about 79.5% and 99.31%, respectively, and the percentages of false alarm and miss were about 20.5% and 0.69%, respectively. That is, the account sharing can be more accurately detected by the CMM method than by the above ASW method. Further, as the experiment by the above ASW method, FIG. 6D shows the results of detecting by the GMM method the number of cases that the accounts are used by one user (16×25=400), the number of cases that the accounts are shared by two users (16×25×₁₅C₁=6000), the number of cases that the accounts are shared by three users (16×25×₁₅C₂=41000), and the number of cases that the accounts are shared by four users (16×25×₁₅C₃=171000) from dataset collected from 16 users' typing 25 passwords 30 times. As shown in FIG. 6D, while the number of the single usage is 400 (each of 400 users uses one account), it was determined by the GMM method that the number of the single usage was 482, that is, the percentage of errors was 20.50%. Furthermore, while the number of the account shared by four users is 182,000 (each of 45,500 accounts is shared by four users), it was determined by the GMM method that the number of account shared by four users was 169,142, that is, the percentage of errors was 7.06%.

In conclusion, while, by one threshold, the above ASW method determines whether the account is used by one user or many users, the above GMM method has the ability to estimate the number of users.

Moreover, the keystroke dynamic pattern information may be analyzed by combining the ASW method and the GMM method. That is, in the first step, whether an account is shared can be determined by the ASW method, and then, in the second step, whether the account is shared can be determined and the number of the users sharing the account can be counted by the GMM method. By such combination of the ASW method and the GMM method, the possibility of a miss or a false alarm can be reduced more. FIGS. 6E and 6F show the tables of the results gained from the combination of the ASW method and the GMM method. As shown in FIG. 6E, the percentage of correctly detecting the single usage is 92.25%, the percentage of correctly detecting the account sharing by two to four users is 92.26%, the percentage of the false alarm that the single usage is regarded as the account sharing is 7.75%, and the percentage of the miss that the account sharing is regarded as the single usage is 7.74%. Further, as shown in FIG. 6F, while the number of the users for single usage is 400 (each of 400 users uses one account), it was determined, by the combination of the ASW method and the GMM method, that the number of the users for single usage was 431, that is, the percentage of errors was 7.75%. As for the account sharing by three users, while the number of the users for account sharing by three users is 42,000 (each of 14,000 accounts is shared by three users), it was determined, by the combination of the ASW method and the GMM method, that the number of the users for single usage was 43,503, that is, the percentage of errors was 3.58%. As described above, the combination of the ASW method and the GMM method seems to detect account sharing more accurately than only one of the ASW method and the GMM method.

Although it was explained that keystroke dynamics pattern information is analyzed by the ASW method, the GMM method, and their combination, the present invention is not limited to the methods, and it is obvious to one of ordinary skill in the art that the keystroke dynamics pattern information can be analyzed by any mathematical or statistical method which can analyze a plurality of data.

Hereinafter, embodiments of a method of detecting account sharing based on keystroke dynamics analysis will be described.

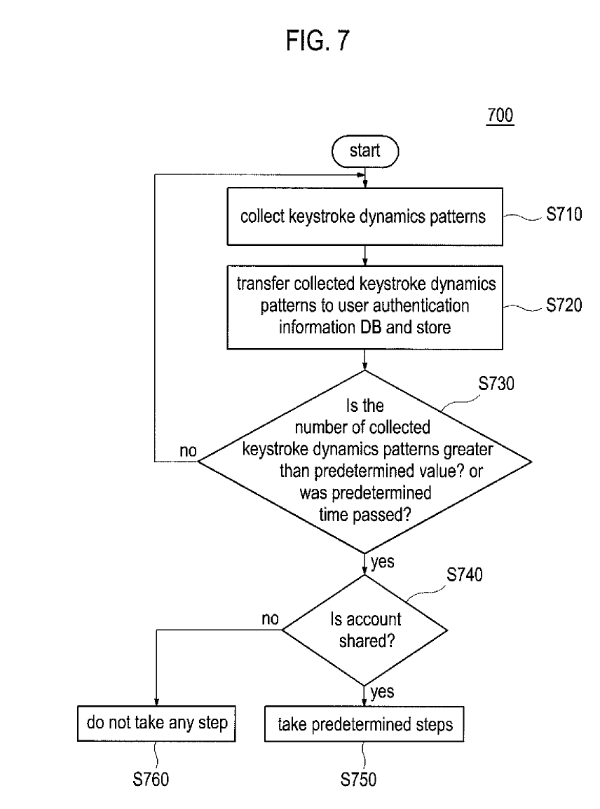

FIG. 7 is a flow chart of a method 700 of detecting account sharing according to an embodiment of the present invention. Referring to FIGS. 8 and 3, in the step S710, the pattern collector 110 in the user devices 212 and 214 collects users' keystroke dynamics patterns, and then in the step S720, the collected keystroke dynamics patterns are transferred to the user authentication information database 120 and stored in the database to be associated with the users' accounts. In the step S730, such steps S710 and S720 of collecting, transferring, and storing the keystroke dynamics patterns may be repeated until the number of the keystroke dynamics patterns stored in the user authentication information database 120 reaches the predetermined value, or the predetermined time passes. Then, in the step S740, the sharing detection analyzer 130 analyzes the keystroke dynamics pattern data stored in the user authentication information database 120 to determine whether an account is shared, and/or the number of users sharing the account. As the method for analyzing the keystroke dynamics patterns, the above ASW method, GMM method, or their combination can be used. According to an embodiment of the present invention, if, as a result of the analysis, it is determined that the account is shared, an alarm message for notifying that the account is shared may be transferred to the user, or a predetermined penalty may be provided to the user in the step S750, and if it is determined that the account is used by a single user, nothing is conducted in step S760.

Furthermore, for achieving the method 700, a general-purpose computer may be adopted. The computer has one or more processors which are connected to a main memory unit having Random Access Memory (RAM) and Read Only Memory (ROM). The processor may be called as a central processing unit (CPU). As well known in the technical field of the present invention, the ROM transfers data and instructions to the CPU in one-way, and the RAM transfers data and instructions in two-ways. The RAM and ROM may include any proper type of computer-readable mediums. A mass storage unit is connected to the processor in two-ways to provide additional data storage, and it may be one of the computer-readable mediums. The mass storage unit is used for storing programs, data, etc., and generally, is an auxiliary storage unit, such as a hard disk which is slower than the main memory unit. A specified mass storage unit, such as CD-ROM, may also be used. The processor is connected to one or more input/output devices, such as a video monitor, a trackball, a mouse, a keyboard, a microphone, a touch-screen display, a card reader, a magnetic or paper tape reader, a voice or writing recognition device, a joystick, and other known computer input/output devices. Finally, the processor may be connected to a wired or wireless network via a network interface. Through such connection to the network, the processes in the method as explained above can be performed. The above devices and units are well known to one of ordinary skill in the technical field of computer hardware and software. The hardware device may consist of one or more modules for performing the method 700.

The foregoing merely describes some exemplary embodiments of the present invention. One skilled in the art will readily recognize from the above descriptions, the accompanying drawings and the claims that various modifications can be made without departing from the spirit and the scope of the appended claims. The above descriptions are thus to be regarded as illustrative rather than limiting.

What is claimed is:

1. A system of detecting account sharing comprising:
a user authentication information database storing keystroke dynamics patterns related to a particular account in association with the account; and
a sharing detection analyzer to analyze a cluster distribution of the keystroke dynamics patterns stored in the user authentication information database to determine whether the account is shared.

2. The system of detecting account sharing of claim 1, wherein the sharing detection analyzer analyzes the keystroke dynamics patterns with measurement of degree of dispersion to determine whether the account is shared.

3. The system of detecting account sharing of claim 1, wherein the sharing detection analyzer analyzes the keystroke dynamics patterns with estimation of an optimum number of clusters or combination of the estimation of an optimum number of clusters and measurement of degree of scatter to determine whether the account is shared and to estimate the number of users who share the account.

4. The system of detecting account sharing of claim 2, wherein the measurement of degree of dispersion is Adjusted Within-Cluster Scatter (ASW).

5. The system of detecting account sharing of claim 3, wherein the estimation of an optimum number of clusters is Gaussian Mixture Model (GMM).

6. The system of detecting account sharing of claim 1, wherein the keystroke dynamics patterns extracted by the pattern collector comprise at least one of an input duration, an interval, and a latency time.

7. The system of detecting account sharing of claim 1, wherein the user authentication information database comprises a first database to store the account and a password related to the account and a second database to store the account and the keystroke dynamics patterns in association with the account.

8. The system of detecting account sharing of claim 1, wherein the keystroke dynamics patterns are generated by the user's inputting an array of strings consisting of a plurality of characters with a keypad including a plurality of keys, or by the user's pushing a single key or button one or more times.

9. A method of detecting account sharing comprising:
collecting keystroke dynamics patterns related to a particular account;
storing the collected keystroke dynamics patterns in a user authentication information database in association with the account; and
analyzing the keystroke dynamics patterns stored in the user authentication information database to determine whether the account is shared.

10. The method of claim 9, wherein said collecting the keystroke dynamics patterns and said storing the keystroke dynamics patterns in the user authentication information database are repeated until a predetermined number of keystroke dynamics patterns are stored or a predetermined time passes.

11. The method of claim 9, wherein said analyzing the keystroke dynamics patterns comprises analyzing the keystroke dynamics patterns with measurement of degree of dispersion to determine whether the account is shared.

12. The method of claim 9, wherein said analyzing the keystroke dynamics patterns comprises analyzing the keystroke dynamics patterns with estimation of an optimum number of clusters or combination of the presumption of an optimum number of clusters and measurement of degree of dispersion to determine whether the account is shared as well as to estimate the number of people who share the account.

13. The method of claim 1 1, wherein the measurement of degree of dispersion is ASW.

14. The method of claim 12, wherein the estimation of an optimum number of clusters is GMM.

15. The method of claim 9, wherein the keystroke dynamics patterns extracted by the pattern collector comprise at least one of an input duration, an interval, and a latency time.

16. The method of claim 9, further comprising:
sending a message for notifying that the account is shared to the user or providing a predetermined penalty to the user if the account is shared.

17. The method of claim 9, wherein the keystroke dynamics patterns are generated by the user's inputting an array of strings consisting of a plurality of characters with a keypad including a plurality of keys, or by the user's pushing a single key or button one or more times.

18. A computer readable medium storing instructions causing a computer program to execute a computer process for providing a method of detecting account sharing, the method comprising:
collecting keystroke dynamics patterns related to a particular account;
storing the collected keystroke dynamics patterns in a user authentication information database in association with the account; and
analyzing the keystroke dynamics patterns stored in the user authentication information database to determine whether the account is shared.

19. A system of detecting account sharing comprising:
a terminal embedded with a pattern collector to extracted keystroke dynamics patterns related to a particular account;
a server to maintain the keystroke dynamics patterns in association with the account; and
a sharing detection analyzer to analyze the keystroke dynamics patterns stored in the server to determine whether the account is shared,
wherein the pattern collector comprising:
an input unit to receive keystroke pattern data from the terminal;
a behavior pattern extraction unit to receive the keystroke pattern data from the input unit and to extract the keystroke dynamics patterns from the keystroke pattern data; and
a transmit unit to send the extracted keystroke dynamics patterns to the server.

20. The system of detecting account sharing of claim 19, wherein the sharing detection analyzer analyzes the keystroke dynamics patterns with measurement of degree of dispersion to determine whether the account is shared.

21. The system of detecting account sharing of claim 19, wherein the sharing detection analyzer analyzes the keystroke dynamics patterns with estimation of an optimum number of clusters or combination of the estimation of an optimum number of clusters and measurement of degree of dispersion to determine whether the account is shared as well as to estimate the number of people who share the account.

22. The system of detecting account sharing of claim 20, wherein the measurement of degree of dispersion is Adjusted Within-Cluster Scatter (ASW).

23. The system of detecting account sharing of claim 21, wherein the presumption of an optimum number of clusters is Gaussian Mixture Model (GMM).

24. The system of detecting account sharing of claim 19, wherein the keystroke dynamics patterns extracted by the pattern collector comprise at least one of an input duration, an interval, and a latency time.

25. The system of detecting account sharing of claim 19, wherein the user authentication information database comprises a first database to store the account and a password related to the account and a second database to store the account and the keystroke dynamics patterns in association with the account.

26. The system of detecting account sharing of claim 19, wherein the keystroke dynamics patterns are generated by the user's inputting an array of strings consisting of a plurality of characters with a keypad including a plurality of keys, or by the user's pushing a single key or button one or more times.
